(19) United States
(12) Patent Application Publication
(10) Pub. No.: US 2023/0163326 A1
(43) Pub. Date: May 25, 2023

(54) SYSTEM AND METHOD FOR ELECTRODE MANAGEMENT IN METAL AIR FUEL CELL STACK

(71) Applicant: LOG 9 MATERIALS SCIENTIFIC PRIVATE LIMITED, BENGALURU (IN)

(72) Inventors: AKSHAY VIVEK SINGHAL, DEOBAND (IN); PRITHVI K. B., MYSORE (IN); ANKUSH RAINA, JAMMU (IN); HEMANT CHARAYA, HISAR (IN)

(21) Appl. No.: 17/921,110

(22) PCT Filed: Apr. 22, 2021
(86) PCT No.: PCT/IN2021/050399

§ 371 Date: Oct. 24, 2022

(30) Foreign Application Priority Data
Apr. 22, 2020 (IN) 202041017299

(51) Int. Cl. H01M 8/0297; H01M 4/86; H01M 8/0273; H01M 8/0276; H01M 8/083

(52) U.S. Cl. CPC H01M 8/0297; H01M 4/86; H01M 8/0273; H01M 8/0276; H01M 8/083; H01M 2004/8684; H01M 2004/8689

(57) ABSTRACT

The embodiments herein disclose a system (1000) for managing electrical connections with electrodes in a metal-air fuel cell. The system (1000) includes a cell frame (101) and one or more anode array (102). The one or more anode array (102) is detachably provided with the cell frame (101). The one or more anode array (102) comprises one or more anode. One or more air cathode (103) is provided with the cell frame (101). One or more connector (105) connects the one or more air cathode (103) and the one or more anode array (102). A snap mechanism (106) is used for locking and unlocking the one or more anode array (102) to the cell frame (101).

### CROSS-REFERENCE TO RELATED APPLICATIONS

The embodiment herein claims the priority of the Indian Non-Provisional Application (NPA) with serial number IN 202041017299 filed on Apr. 22, 2020 with the title “SYSTEM AND METHOD FOR ELECTRODE MANAGEMENT IN METAL AIR FUEL CELL STACK”, and the contents of which are included entirely as reference herein.

### BACKGROUND

### Technical Field

The embodiments herein is generally related to fuel cells. The embodiments herein are particularly related to management of electrodes in a fuel cell stack. The embodiments herein are more particularly related to management of electrical connections with electrodes in a fuel cell stack. The embodiments herein are also related to an automated mechanism for connecting and disconnecting electrodes in a plurality of metal air fuel cells, metal-air batteries and alkaline fuel cells.

### Description of the Related Art

In general, metal air fuel cells are electrochemical cells that utilize a pure metal as anode and an external cathode in an aqueous electrolyte. A specific capacity and energy density of the metal air fuel cells are higher compared to Lithium-ion batteries used most widely currently. However, complications in easy usage of electrodes and electrolytes have hindered the development of the metal air fuel cells.

For an optimum performance of the metal air fuel cells, it is necessary for an active area of the anode to be equal to an active area of the cathode, as the cathode absorbs electrons in the metal air fuel cells. Since a rate of reactions of an anode material and a cathode material are not the same, where the cathode usually has a lesser rate of reaction compared to the anode, there is a need for a design of the cell in such a way that there is a plurality of cathodes absorbing the electrons from an anode.

Hence there is a need for a connector mechanism for enabling electrodes arrangement in fuel cells. Further, there is a need for connecting a plurality of metal air fuel cells in an easy manner. Yet there is a need for automating the connection of a plurality of electrodes in the metal air fuel cells. Yet further there is a need for achieving the quick and simultaneous mechanical refilling of the plurality of metal anodes in the cell stack.

The abovementioned shortcomings, disadvantages and problems are addressed herein, which will be understood by reading and studying the following specification.

### Objectives of the Embodiments Herein

The primary object of the embodiments herein is to provide a method and a system of connecting a plurality of electrodes in metal air fuel cells both in series and parallel manner.

Another object of the embodiment herein is to enable an automated mechanism to connect and disconnect electrodes in a plurality of metal air fuel cells.

Yet another object of the embodiment herein is to provide a design of a metal air fuel cell where the electrodes are easily replaceable in the metal air fuel cell.

Yet another object of the embodiment herein is to enable a quick and simultaneous mechanical refilling of a plurality of metal anodes in a metal air fuel cell stack, wherein each stack comprises the plurality of metal air fuel cells.

Yet another object of the embodiment herein is to integrate the electrical connectors embedded within a cell cap with the help of locators, where the mechanical assembly is enabled through coupling mechanisms including nut, bolts, snap fits and magnetic clamp.

Yet another object of the embodiment herein is to provide a dovetail groove and a fixture design in the connector clip to tightly grip and hold the metal anodes and air cathodes, thereby preventing physical detachment of the electrodes and stopping a loss of electrical connection.

Yet another object of the embodiment herein is to enable an equal active area of anode and cathode in a metal air fuel cell to achieve maximum energy and power output from the cell.

Yet another object of the embodiment herein is to enable a snap-fit arrangement to hermetically seal the connector cap with the cell from the top.

Yet another object of the embodiment herein is to overcome the Ohmic losses due to high discharge current in a metal air fuel cell by optimizing a cross-sectional area and thickness of the electrical connectors, thereby minimizing its internal resistance.

Yet another object of the embodiment herein is to provide a connector clip made of a highly conductive material such as Copper or Silver, coated with an alkaline resistive material such as Nickel, Silver, Gold or conductive polymers, to protect the clips from corroding.

Yet another object of the embodiment herein is to provide an automated mechanism to connect and disconnect electrodes in the plurality of metal air fuel cells.

These and other objects and advantages of the embodiments herein will become readily apparent from the following detailed description taken in conjunction with the accompanying drawings.

### SUMMARY

The embodiments herein provide a system and method of connecting a plurality of electrodes in metal air fuel cells. The anode of the metal air fuel cells is in form of an array of metallic cassettes that is designed to be inserted in an arrangement of air cathode and electrolyte in a cell stack. The system also comprises a specialized electrical connector that connects the metallic anode and the air cathode in series and/or parallel connection. The anode array also comprises a snap-fit mechanism to lock and unlock the array to the cell stack. The top part of the array of metallic anode is designed to collect the gas evolved during the electrochemical reaction. The top lid of the arrangement comprises a plurality of nozzles for the passage of the gas evolved during the electrochemical reaction. The system also comprises a gasket to completely seal the cells and prevent the leakage of electrolyte and gas.

According to one embodiment herein, a system is provided with an automated mechanism to connect and disconnect electrodes in a plurality of metal air fuel cells. The array of metallic cassettes, which are designed to be the anode of the fuel cells, are configured to be inserted between two air cathodes in a cell stack. The arrangement ensures that the active area of the anode and active area of cathode are optimum in ensuring the required electrochemical reaction. The arrangement also enables a fully or partially automated system, such as a robotic-aim-based manipulator, to insert and remove the anode array into the cells.

According to one embodiment herein, a metallic connector for connecting the electrodes in a metal air fuel cell is provided. Due to the differences in the rate of reactions, a plurality of cathodes is connected to an anode to ensure a sustained electrochemical reaction to produce electricity.

According to one embodiment herein, the metallic connector is designed to connect a plurality of cathodes in parallel and connect them with an anode in series.

According to one embodiment herein, conductive polymers, or metals, or alloys are provided for enabling electrical connections in metal air fuel cells. The conductive polymers are designed to operate in an alkaline environment and maintain electrical conductivity. The conductive polymers, or metals, or alloys are designed to provide resistance to corrosion and minimize Ohmic losses due to high discharge current in a metal air fuel cell by optimizing the cross-sectional area and thickness of the electrical connectors, thereby minimizing its internal resistance.

According to one embodiment herein, a system is provided for a quick and simultaneous mechanical refilling of a plurality of metal anodes in a cell stack, wherein each stack comprises a plurality of cells. Each cell is provided with a mechanical assembly method, such as snap-fit arrangement or mechanical fastening, to hermetically seal the connector cap with the cell from the top. The electrical connectors are embedded within a cell cap with the help of locators, where the mechanical assembly is enabled through coupling mechanisms including nut and bolts, snap fits and magnetic clamp.

According to one embodiment herein, a dovetail groove and fixture design in the connector clip is provided to tightly grip and hold the metal anodes and air cathodes, thereby preventing physical detachment of the electrodes and stopping a loss of electrical connection.

According to one embodiment herein, a connector clip is made of a highly conductive material such as Copper or Silver, coated with an alkaline resistive material such as Nickel, Silver or Gold, to protect the clips from corroding.

The embodiments herein disclose a system for managing an electrode in an air fuel cell stack. The system includes a cell frame and one or more anode array. The one or more anode array is detachably provided with the cell frame and the one or more anode array comprises one or more anode. One or more air cathode is provided with the cell frame. One or more connectors connect the one or more air cathode and the one or more anode array. A snap mechanism is used for locking and unlocking the one or more anode array to the cell frame.

According to an embodiment herein, the system further includes one or more nozzle providing a passage of gas evolution during an electrochemical reaction. The one or more nozzles is placed on a lid.

According to an embodiment herein, the system further includes a gas evolution section and a gasket sealing the air fuel cell stack and preventing a leakage of electrolyte and gas from the system.

According to an embodiment herein, the system further includes a lid covering the cell frame, the one or more anode array, the one or more air cathode, one or more nozzle, the one or more connector, a gas evolution section, and a gasket.

According to an embodiment herein, the one or more connector connects one or more air cathode in a parallel.

According to an embodiment herein, the one or more connector connects the one or more cathode and the one or more anode array in a series manner.

According to an embodiment herein, a top part of the one or more anode array is designed to collect a gas evolved during an electrochemical reaction in the system.

According to an embodiment herein, a first anode from the anode array is configured to be inserted between two air cathodes in the air fuel cell stack, so as to ensure that an active area of the first anode and an active area of the two air cathodes to perform an electrochemical reaction.

According to an embodiment herein, the system further comprises a connector clip made of a highly conductive material coated with an alkaline resistive material.

According to an embodiment herein, the system further comprises a dovetail groove and fixture design in a connector clip is provided to tightly grip and hold anodes and the one or more air cathodes.

The embodiments herein disclose a method for managing an electrode in an air fuel cell stack. The method includes providing a cell frame. Further, the method includes providing one or more anode array, where the one or more anode array is detachably provided with the cell frame and where the one or more anode array comprises one or more anode. Further, the method includes providing one or more air cathode with the cell frame. Further, the method includes connecting the one or more air cathode and the one or more anode array by using one or more connector. Further, the method includes locking and unlocking the one or more anode array to the cell frame by using a snap mechanism.

According to an embodiment herein the system enables a quick and simultaneous mechanical refilling of a plurality of metal anodes in a metal air fuel cell stack, wherein each stack comprises the plurality of metal air fuel cells. According to an embodiment herein, in a metal-air fuel cell, the metal such as Aluminum acts as fuel and therefore gets consumed during the operation of the fuel cell, and hence those metal plates are replaced on regular basis as part of refueling process. The process of replacing the metal plates for every cell in a typical cell stack (comprising of >10 cells) is very time consuming as the Anode and Cathode of each individual cell are to be connected and also all the cells need to be electrically connected, thereby consuming a lot of time for refueling process. So, system provides quick and easy connector mechanism so that the replacement of metal plate of all the individual cells is done easily in single step, thereby simplifying the whole process and reducing the down time.

According to an embodiment herein a cap is provided in each stack and the cap of each stack is designed in such a way that all the connections such as anodes and cathode connection of individual cell and the series connection between the cells are performed simultaneously. All electrical connections are provided/established through clips that are embedded in the cap in such a way that only the top cap is to be replaced during every re-fueling process/time.

According to an embodiment herein, the anode array (metal cassettes) are embedded with the cell cap and connected through the connection clips. The connector clips are designed and setup in the cap in such manner that all the cells get electrically connected when this anode array is inserted into the cell frame.

According to an embodiment herein, the electrical connectors embedded within a cell cap are integrated with the help of locators, and the mechanical assembly is enabled through coupling mechanisms including nut, bolts, snap fits and magnetic clamp.

According to an embodiment herein, a dovetail groove and a fixture design is provided in the connector clip to tightly grip and hold the metal anodes and air cathodes, thereby preventing physical detachment of the electrodes and preventing a loss of electrical connection.

According to an embodiment herein, the size of the metal cassette is adjusted/modified or selected based on a user requirement the current capacity of the fuel cells is to achieve an equal active area of anode and cathode in a metal air fuel cell to achieve maximum energy and power output from the cell, as the rate of reaction (activity) of the cathode and anode is mutually different.

According to an embodiment herein, a snap-fit arrangement is provided to hermetically seal the connector cap with the cell from the top, since the alkaline (potentially corrosive) electrolyte flows through the cell stack. An effective sealing is provided to prevent the electrolyte leakage. The offset in snap-fit arrangement is reduced/minimized so that the cell cap hermetically seals the cells and thereby preventing leakage of electrolyte from the cell stack.

According to an embodiment herein, the size of the connector clip such as length. width and height of the connector clip is modified based on user requirement of the current carrying/supplying capacity (amperage) of the fuel cells to overcome/reduce the Ohmic losses (current losses due to internal resistance) due to high discharge current in a metal air fuel cell by optimizing a cross-sectional area and thickness of the electrical connectors, thereby minimizing its internal resistance.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates an exploded perspective view of a metal air fuel cell stack, according to an embodiment herein.

FIGS. 2a-2d illustrate perspective views and side views of a metallic connector for connecting electrodes in a metal air fuel cell, according to an embodiment herein.

FIGS. 3a-3d illustrate perspective views and side views of a metallic connector for connecting an anode electrode in a cell to a cell mounting of a metal air fuel cell stack, according to an embodiment herein.

FIGS. 4a-4d illustrate perspective views and side views of a metallic connector for connecting a cathode electrode in a cell to the cell mounting of a metal air fuel cell stack arrangement, according to an embodiment herein.

FIGS. 5a-5d illustrates a perspective and side views of a metallic full snap slider connector used in a metal air fuel cell stack arrangement, according to an embodiment herein.

FIG. 6 illustrates an exploded assembly view of the arrangement of electrodes in a cell stack arrangement of a metal air fuel cell, according to an embodiment herein.

FIG. 7 illustrates a flow chart explaining a method for managing the electrode in the air fuel cell stack, according to an embodiment herein.

FIG. 8 illustrates two metal air fuel cell stacks that are to be connected in a metal air fuel cells according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments herein are described in sufficient detail to enable those skilled in the art to practice the embodiments and it is to be understood that other changes may be made without departing from the scope of the embodiments herein. The following detailed description is therefore not to be taken in a limiting sense.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive “or”, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The accompanying drawings are used to help easily understand various technical features and it should be understood that the embodiments presented herein are not limited by the accompanying drawings. As such, the present disclosure should be construed to extend to any alterations, equivalents and substitutes in addition to those, which are particularly set out in the accompanying drawings. Although the terms first, second, etc. may be used herein to describe various elements, these elements should not be limited by these terms. These terms are generally only used to distinguish one element from another.

The embodiments herein provide a system and method of connecting a plurality of electrodes in metal air fuel cells. The anode of the metal air fuel cells is in form of an array of metallic cassettes that is designed to be inserted in an arrangement of air cathode and electrolyte in a cell stack. The system also comprises a specialized electrical connector that connects the metallic anode and the air cathode in series and/or parallel connection. The anode array also comprises a snap-fit mechanism to lock and unlock the array to the cell stack. The top part of the array of metallic anode is designed to collect the gas evolved during the electrochemical reaction. The top lid of the arrangement comprises a plurality of nozzles for the passage of the gas evolved during the electrochemical reaction. The system also comprises a gasket to completely seal the cells and prevent the leakage of electrolyte and gas.

According to one embodiment herein, a system is provided with an automated mechanism to connect and disconnect electrodes in a plurality of metal air fuel cells. The array of metallic cassettes, which are designed to be the anode of the fuel cells, are configured to be inserted between two air cathodes in a cell stack. The arrangement ensures that the active area of the anode and active area of cathode are optimum in ensuring the required electrochemical reaction. The arrangement also enables a fully or partially automated system, such as a robotic-arm-based manipulator, to insert and remove the anode array into the cells.

According to one embodiment herein, a metallic connector for connecting the electrodes in a metal air fuel cell is provided. Due to the differences in the rate of reactions, a plurality of cathodes is connected to an anode to ensure a sustained electrochemical reaction to produce electricity.

According to one embodiment herein, the metallic connector is designed to connect a plurality of cathodes in parallel and connect them with an anode in series.

According to one embodiment herein, the conductive polymers, or metals, or alloys are provided for enabling electrical connections in metal air fuel cells. The conductive polymers are designed to operate in an alkaline environment and maintain electrical conductivity. The conductive polymers, or metals, or alloys are designed to provide resistance to corrosion and minimize Ohmic losses due to high discharge current in a metal air fuel cell by optimizing the cross-sectional area and thickness of the electrical connectors, thereby minimizing its internal resistance.

According to one embodiment herein, a system is provided for a quick and simultaneous mechanical refilling of a plurality of metal anodes in a cell stack, wherein each stack comprises a plurality of cells. Each cell is provided with a mechanical assembly method, such as snap-fit, arrangement or mechanical fastening, to hermetically seal the connector cap with the cell from the top. The electrical connectors are embedded within a cell cap with the help of locators, where the mechanical assembly is enabled through coupling mechanisms including nut and bolts, snap fits, and magnetic clamp.

According to one embodiment herein, a dovetail groove and fixture design in the connector clip is provided to tightly grip and hold the metal anodes and air cathodes, thereby preventing physical detachment of the electrodes and stopping a loss of electrical connection.

According to one embodiment herein, a connector clip is made of a highly conductive material such as Copper or Silver, coated with an alkaline resistive material such as Nickel, Silver or Gold, to protect the clips from corroding.

The embodiments herein disclose a system for managing an electrode in an air fuel cell stack. The system includes a cell frame and one or more anode array. The one or more anode array is detachably provided with the cell frame and the one or more anode array comprises one or more anode. One or more air cathode is provided with the cell frame. One or more connectors connect the one or more air cathode and the one or more anode array. A snap mechanism is used for locking and unlocking the one or more anode array to the cell frame.

According to an embodiment herein, the system further includes one or more nozzle providing a passage of gas evolution during an electrochemical reaction. The one or more nozzles is placed on a lid.

According to an embodiment herein, the system further includes a gas evolution section and a gasket sealing the air fuel cell stack and preventing a leakage of electrolyte and gas from the system.

According to an embodiment herein, the system further includes a lid covering the cell frame, the one or more anode array, the one or more air cathode, one or more nozzle, the one or more connector, a gas evolution section, and a gasket.

According to an embodiment herein, the one or more connector connects one or more air cathode in a parallel.

According to an embodiment herein, the one or more connector connects the one or more cathode and the one or more anode array in a series manner.

According to an embodiment herein, a top part of the one or more anode array is designed to collect a gas evolved during an electrochemical reaction in the system.

According to an embodiment herein, a first anode from the anode array is configured to be inserted between two air cathodes in the air fuel cell stack, so as to ensure that an active area of the first anode and an active area of the two air cathodes to perform an electrochemical reaction.

According to an embodiment herein, the system further comprises a connector clip made of a highly conductive material coated with an alkaline resistive material.

According to an embodiment herein, the system further comprises a dovetail groove and fixture design in a connector clip is provided to tightly grip and hold anodes and the one or more air cathodes.

The embodiments herein disclose a method for managing an electrode in an air fuel cell stack. The method includes providing a cell frame. Further, the method includes providing one or more anode array, where the one or more anode array is detachably provided with the cell frame and where the one or more anode array comprises one or more anode. Further, the method includes providing one or more air cathode with the cell frame. Further, the method includes connecting the one or more air cathode and the one or more anode array by using one or more connector. Further, the method includes locking and unlocking the one or more anode array to the cell frame by using a snap mechanism

The embodiments herein disclose a system for managing an electrode in an air fuel cell stack. The system includes a cell frame and one or more anode array. The one or more anode array is detachably provided with the cell frame and the one or more anode array comprises one or more anode. One or more air cathode is provided with the cell frame. One or more connectors connect the one or more air cathode and the one or more anode array. A snap mechanism is used for locking and unlocking the one or more anode array to the cell frame.

According to an embodiment herein the system enables a quick and simultaneous mechanical refilling of a plurality of metal anodes in a metal air fuel cell stack, wherein each stack comprises the plurality of metal air fuel cells. According to an embodiment herein, in a metal-air fuel cell, the metal such as Aluminum acts as fuel and therefore gets consumed during the operation of the fuel cell, and hence those metal plates are replaced on regular basis as part of refueling process. The process of replacing the metal plates for every cell in a typical cell stack (comprising of >10 cells) is very time consuming as the Anode and Cathode of each individual cell are to be connected and also all the cells need to be electrically connected, thereby consuming a lot of time for refueling process. So, system provides quick and easy connector mechanism so that the replacement of metal plate of all the individual cells is done easily in single step, thereby simplifying the whole process and reducing the down time.

According to an embodiment herein a cap is provided in each stack and the cap of each stack is designed in such a way that all the connections such as anodes and cathode connection of individual cell and the series connection between the cells are performed simultaneously. All electrical connections are provided/established through clips that are embedded in the cap in such a way that only the top cap is to be replaced during every re-fueling process/time.

According to an embodiment herein, the anode array (metal cassettes) are embedded with the cell cap and connected through the connection clips. The connector clips are designed and setup in the cap in such manner that all the cells get electrically connected when this anode array is inserted into the cell frame.

According to an embodiment herein, the electrical connectors embedded within a cell cap are integrated with the help of locators, and the mechanical assembly is enabled through coupling mechanisms including nut, bolts, snap fits and magnetic clamp.

According to an embodiment herein, a dovetail groove and a fixture design is provided in the connector clip to tightly grip and hold the metal anodes and air cathodes, thereby preventing physical detachment of the electrodes and preventing a loss of electrical connection.

According to an embodiment herein, the size of the metal cassette is adjusted/modified or selected based on a user requirement the current capacity of the fuel cells is to achieve an equal active area of anode and cathode in a metal air fuel cell to achieve maximum energy and power output from the cell, as the rate of reaction (activity) of the cathode and anode is mutually different.

According to an embodiment herein, a snap-fit arrangement is provided to hermetically seal the connector cap with the cell from the top, since the alkaline (potentially corrosive) electrolyte flows through the cell stack. An effective sealing is provided to prevent the electrolyte leakage. The offset in snap-fit arrangement is reduced/minimized so that the cell cap hermetically seals the cells and thereby preventing leakage of electrolyte from the cell stack.

According to an embodiment herein, the size of the connector clip such as length, width and height of the connector clip is modified based on user requirement of the current carrying/supplying capacity (amperage) of the fuel cells to overcome/reduce the Ohmic losses (current losses due to internal resistance) due to high discharge current in a metal air fuel cell by optimizing a cross-sectional area and thickness of the electrical connectors, thereby minimizing its internal resistance.

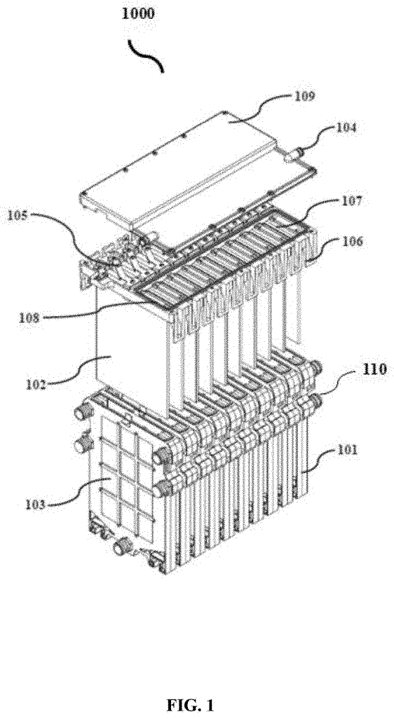

FIG. 1 illustrates an exploded perspective view of a system (1000) for managing an electrode in an air fuel cell stack. The electrode can be, for example, but not limited to an anode and an air cathode (103). The air fuel cell stack comprises a plurality of fuel cells. In an example, the fuel cell is a device which directly converts chemical energy stored in a fuel such as hydrogen or methane into electrical energy by means of an electrochemical reaction. The fuel cell can be, for example, but not limited to a polymer electrolyte fuel cell, a solid oxide fuel cell or the like. The system (1000) comprises a cell frame (101), metallic cassettes as an anode array (102), the air cathode (103), one or more nozzles (104), a connector (105) (i.e., electrically conductive connector), a snap mechanism (106), a gas evolution section (107), a gasket (108), a lid (109), and a roller arrangement (110).

Further, the cell frame (101) is being configured by arranging the plurality of full cells. The nozzles (104) are used for the passage of gas evolution during an electrochemical reaction. The nozzles (104) are arranged on the lid (109). In an embodiment, end portions of the nozzles (104) are placed outside of the lid (109) and remaining portion (i.e., center portions) of the nozzles (104) are placed inside of the lid (109). The connector (105) is used for connecting the air cathode (103) and the anode array (102) in series or parallel connections. The snap mechanism (106) is used for locking/unlocking the anode array (102) to the cell frame (101). The gas evolution section (107) and the gasket (108) completely seal the cells and prevent the leakage of electrolyte and gas in the system (1000). The lid (109) protects the various parts of the system (1000).

The anode array (102) is in form of an array of metallic cassettes that is designed to be inserted in an arrangement of the air cathode (103) and electrolyte in the cell stack. A top part of the anode array (102) of a metallic anode is designed to collect the gas evolved during the electrochemical reaction.

Further, the system (1000) is also provided with an automated mechanism (not shown) to connect and disconnect the electrodes in the plurality of metal air fuel cells. The array of metallic cassettes, which are designed to be the anode of the fuel cells, are configured to be inserted between two air cathodes in the cell stack, so as to ensures that an active area of the anode array (102) and an active area of the are cathode (103) are ensuring the required electrochemical reaction in a better manner. The system (1000) also enables a fully or partially automated system, such as a robotic-arm-based manipulator, to insert and remove the anode array (102) into the cells.

According to an embodiment herein, the snap fit system is provided with a tool/mechanism designed easily to remove the snap and carry out the mechanical refueling in a facile manner by applying a force simultaneously to two tongs/arms of the snap fit mechanism to pull apart the two arms away to release the cassette.

Further, due to the differences in the rate of reactions, a plurality of air cathode (103) is connected to the anode array (102) to ensure a sustained electrochemical reaction to produce electricity.

According to an embodiment herein, an electrolyte tank is provided in metal-air fuel cells to store the alkaline electrolyte. When the operation of the fuel cell is started, this electrolyte is pumped from the electrolyte tank to the cell stack. Inside the cell stack, the electrolyte reacts with the metal (to form metal hydroxide) and in return electricity is generated. This is a continuous process meaning that the electrolyte is continuously pumped from tank to cell stack and back to the tank during the operation of the fuel cell.

Further, in the system (1000), conductive polymers, or metals, or alloys are provided for enabling electrical connections in the metal air fuel cells. The conductive polymers are designed to operate in an alkaline environment and maintain electrical conductivity. The conductive polymers, or metals, or alloys are designed to provide resistance to corrosion and minimize Ohmic losses due to high discharge current in the metal air fuel cell by optimizing the cross-sectional area and thickness of the electrical connectors, thereby minimizing its internal resistance.

According to an embodiment herein, these metal air fuel cells are provided with alkaline electrolyte which is very corrosive to the metals. Therefore it is advantageous to use polymer to improve/increase conductivity and to provide a corrosion-free environment.

Further, in the system (1000), a dovetail groove and fixture design in the connector clip is provided to tightly grip and hold the metal anodes and the air cathodes (103), thereby preventing physical detachment of the electrodes and stopping a loss of electrical connection. Further, the connector clip is made of a highly conductive material such as Copper or Silver, coated with an alkaline resistive material such as Nickel, Silver or Gold, or conductive polymers to protect the clips from corroding.

According to an embodiment herein, the connector clip is provided with two major sections with a groove in between to plug-in/receive the metal cassette, to hold the anode of n+1th cell (last cell) and also electrically connect it with the cathode of nth cell(penultimate cell). The connector clips also have the spring effect to improve/increase a contact strength with the air cathodes.

According to an embodiment herein the metal such as Aluminum acts as fuel in a metal-air fuel cell and therefore gets consumed during the operation of the fuel cell. So, there is a need to replace those metal plates on regular basis as part of refueling process. The replacement of metal plates on regular basis for every cell in a typical cell stack (comprising of >10 cells) consumes a lot of time since the Anode and Cathode of each individual cell are to be connected and also all the cells need to be electrically connected. This takes a lot of time for refueling process. So, there is a need to provide a system where the replacement of metal plate of all the individual cells is done in single step. This makes the whole process much easier and the down time is also less.

With respect to FIG. 1, the cap of each stack is designed in such a way that all the connections, comprising anodes and cathode connection of individual cells and (2) series connection between the cells, happens simultaneously. All the electrical connections between clips (105) are embedded in the cap in such a way that the top cap is replaced every re-fueling process/period. The anode array (metal cassettes)—102 are embedded with the cell cap and connected through the connection clips. The connector clips are designed and setup in the cap in such as way that when this anode array is inserted into the cell frame 101 all the cells get electrically connected.

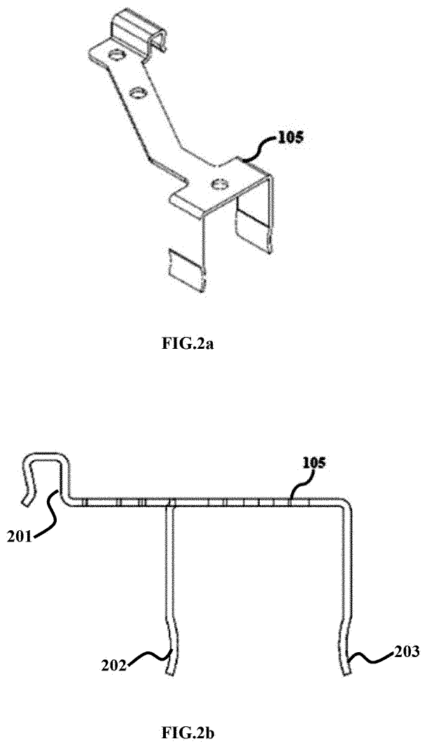

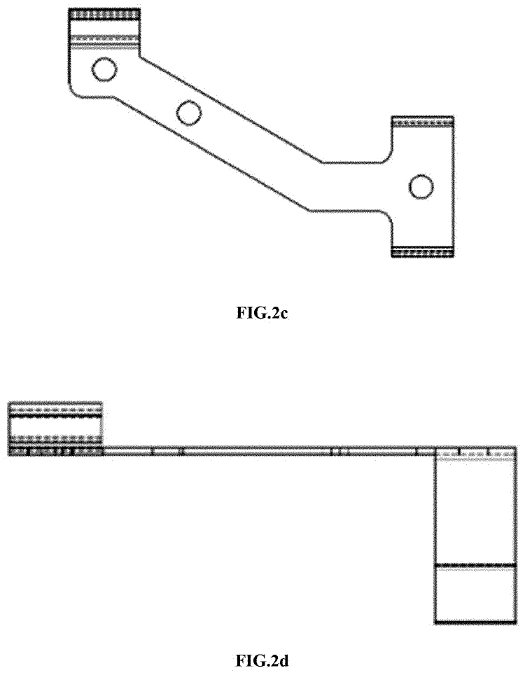

FIGS. 2a-2d illustrate perspective and side views of the metallic connector (105) for connecting the electrodes (e.g., air cathode (103) and the anode array (102)) in the metal air fuel cell. The metallic connector (105) is designed to connect the plurality of air cathodes (103) in parallel and connect them with an anode in series.

FIG. 2 represents the connector clip design. As shown in FIG. 2, the connector has two major sections provided with a groove (201) to plug-in the metal cassette, so that the groove is designed to hold the anode of n+1th cell and also electrically the connect the anode of the n+1th cell with the cathodes of nth cell (202,203). The connector clips also have the spring effect wherein it makes a very good contact with the air cathodes.

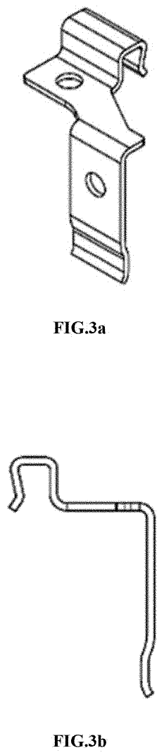

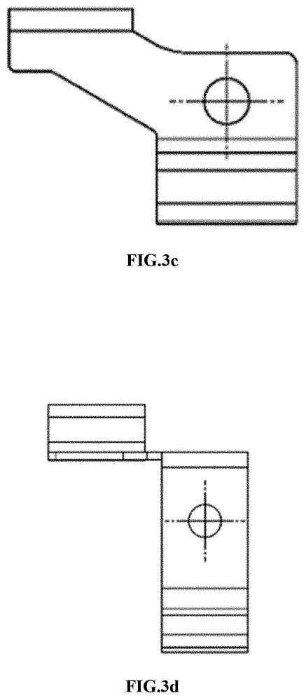

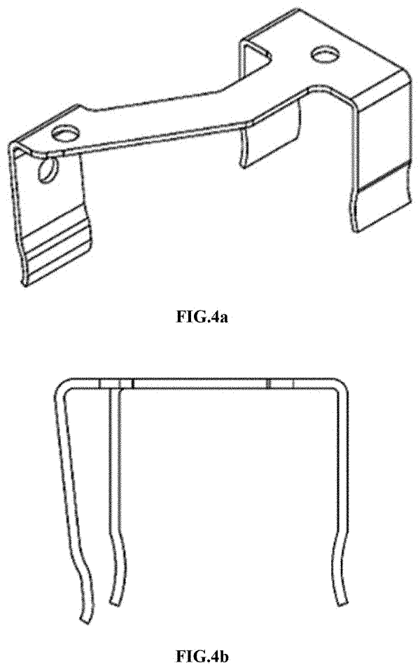

FIGS. 3a-3d illustrate perspective and side views of the metallic connector (105) for connecting the anode electrode in a cell to the cell mounting of the metal air fuel cell stack.

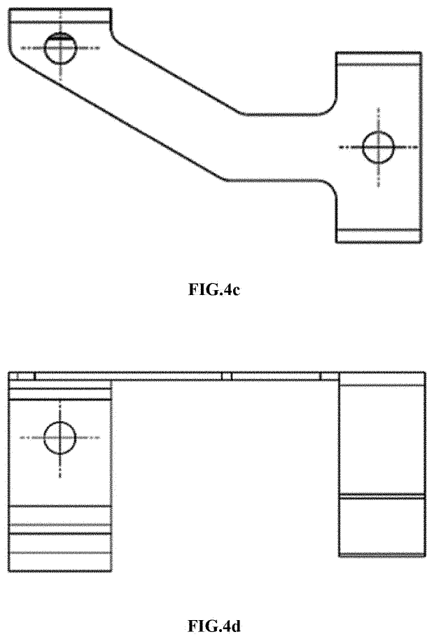

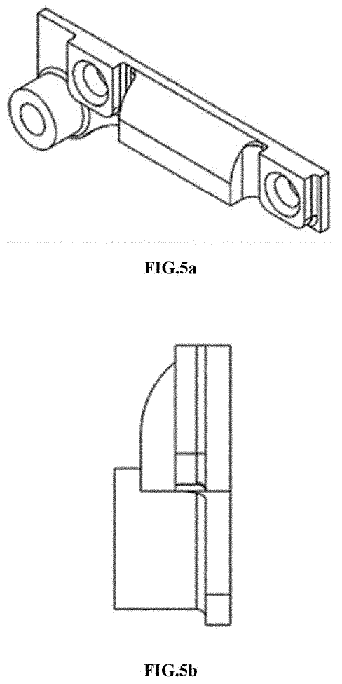

FIGS. 4a-4d illustrate perspective and side views of the metallic connector (105) for connecting a cathode electrode in a cell to the cell mounting of the metal air fuel cell stack.

The function of the connector clips (803, 801) in FIG. 3 and FIG. 4 is also the same as that of connector clips (802) in FIG. 2. The only difference is that they are present at either ends (one anode at FIG. 3 end and cathode at FIG. 4 end) of the cell stack from where the connection to the load is given. Also, the end of these clips is designed in such a way that the anode end (connector clip in FIG. 3) is directly connected to the cathode end (connector clip in FIG. 4). thus the two cell stacks are connected together while building the module.

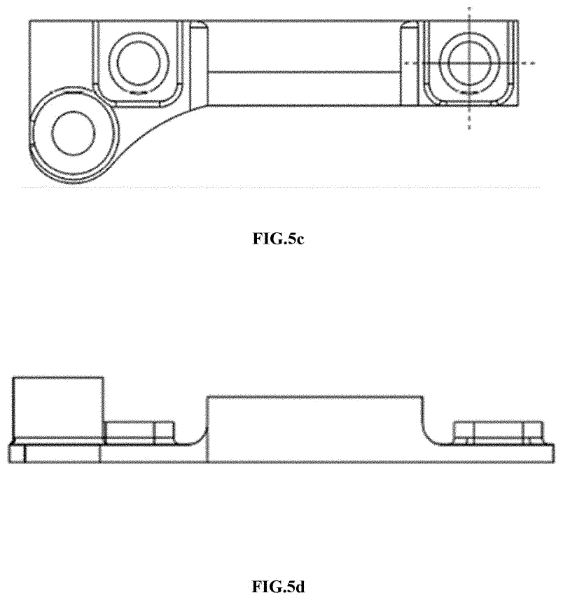

FIGS. 5a-5d illustrate perspective and side views of a metallic full snap slider connector used in the metal air fuel cell stack. These are the connectors (804) that are mounted on last and first cells of the cell stack. The idea here is to ensure the stack-to-stack connection becomes easier.

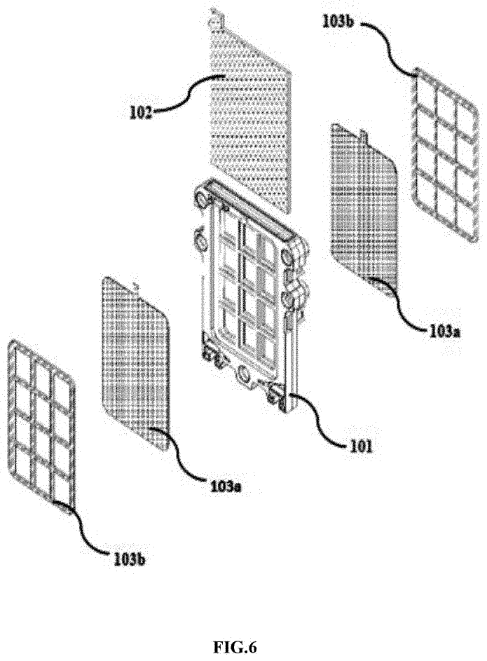

FIG. 6 illustrates an exploded view of the arrangement of electrodes in the metal air fuel cell stack. An air-cathode electrode (103b) is embedded with a mesh of conductive and sturdy material to provide rigidity to the electrode and prevent the mechanical buckling of the electrode due to pressure. With respect to FIG. 6, the construction of each cell in the cell stack of the metal-air fuel cell is shown. There is a continuous electrolyte flow through the cell stack which apply pressure on the air cathodes. By providing the mesh structure on either side of the air cathode, it is ensured the pressure on the air cathode is minimized and they do not tear-apart during the operation

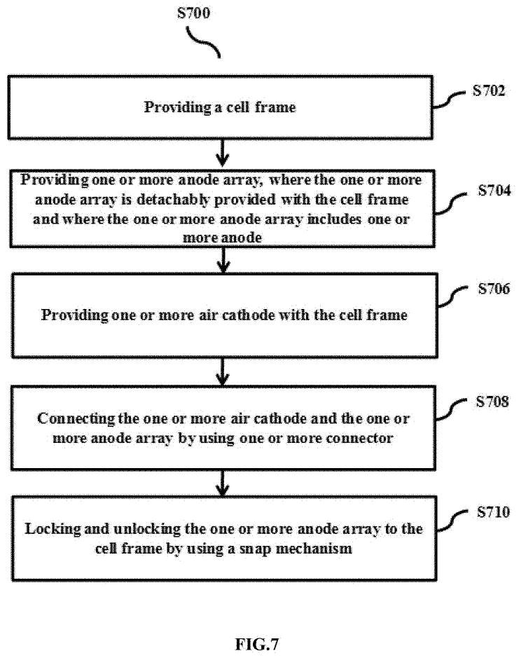

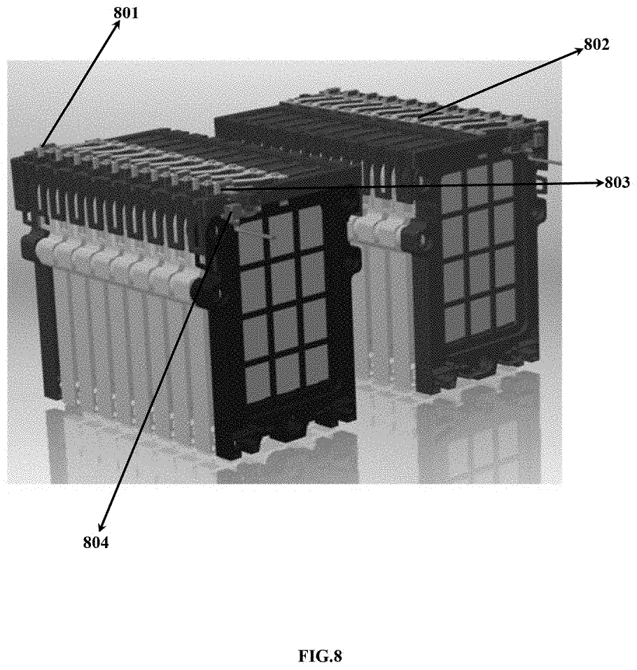

FIG. 7 is a flow chart (S700) illustrating a method for managing the electrode in the metal air fuel cell stack, according to one embodiment of the embodiments herein. At S702, the method includes providing the cell frame (101). At S702, the method includes providing one or more anode array (102), where the one or more anode array (102) is detachably provided with the cell frame (101) and where the one or more anode array (102) comprises one or more anode. At S706, the method includes providing one or more air cathode (103) with the cell frame (101). At S708, the method includes connecting the one or more air cathode (103) and the one or more anode array (102) by using one or more connector (105). At S710, the method includes locking and unlocking the one or more anode array (102) to the cell frame (101) by using the snap mechanism (106).

FIG. 8 illustrates two metal air fuel cell stacks that are to be connected in a metal air fuel cell according to an embodiment herein. The stacks are provided with four connectors (801-804) for connecting the two air fuel cell stacks together. The metallic connector 802 is used for connecting electrodes in a metal air fuel cell as illustrated in FIGS. 2a-2d. The metallic connector 803 is used for connecting an anode electrode in a cell to a cell mounting of a metal air fuel cell stack, as illustrated in FIG. 3a-FIG. 3d. The metallic connector 801 is used for connecting a cathode electrode in a cell to the cell mounting of a metal air fuel cell stack arrangement, as illustrated in FIG. 4a-FIG. 4d. The metallic full snap slider connector 804 is used in a metal air fuel cell stack arrangement, as illustrated in FIG. 5a-FIG. 5d.

The embodiments herein provide a method for the quick and simultaneous mechanical refilling of the plurality of metal anodes in the cell stack, wherein each stack comprises the plurality of cells. The electrical connectors are embedded within a cell cap with the help of locators, where the mechanical assembly is enabled through coupling mechanisms including nut & bolts, snap fits and magnetic clamp.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

The present invention is related to system and method for connecting a plurality of electrodes in metal air fuel cells. The embodiments herein are also related to enabling an automated mechanism to connect and disconnect the electrodes in a plurality of metal air fuel cells. The embodiments herein provide a system to ensure that the active area of the anode and active area of cathode are optimum in ensuring the required electrochemical reaction. The embodiments herein also disclose a fully or partially automated system, such as a robotic-arm-based manipulator, to insert and remove the anode array into the cells.

The embodiments herein also disclose a metallic connector that is designed to connect a plurality of cathodes in parallel and connect them with an anode in series, which ensures a sustained electrochemical reaction to produce electricity. The embodiments herein disclose a system comprising conductive polymers to operate in an alkaline environment and maintain electrical conductivity. The conductive polymers are designed to provide resistance to corrosion and minimize Ohmic losses when the current is high.

Unlike the conventional methods and systems, the system of the embodiments herein is used for connecting the plurality of electrodes in the metal air fuel cells in an easy manner and enabling an automated mechanism to connect and disconnect electrodes in the plurality of metal air fuel cells. The system disclosed in the embodiments herein ensures that the active area of the anode and active area of cathode are optimum in ensuring the required electrochemical reaction. The system also enables a fully or partially automated system, such as a robotic-arm-based manipulator, to insert and remove the anode array into the cells. The metallic connector is designed to connect the plurality of cathodes in parallel and connect them with an anode in series, which ensures a sustained electrochemical reaction to produce electricity.

The system enables a quick and simultaneous mechanical refilling of the plurality of metal anodes in the cell stack. In the system, the dovetail groove and the fixture design in the connector clip to tightly grip and hold the metal anodes and air cathodes, so as to prevent physical detachment of the electrodes and stop a loss of electrical connection. The system avoids the Ohmic losses due to high discharge current in the metal air fuel cell by optimizing a cross-sectional area and thickness of the electrical connectors, thereby minimizing its internal resistance. In the system, the electrodes are easily replaceable. The connector clip made of a highly conductive material coated with an alkaline resistive material to protect the clip from corroding.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system (1000) for managing an electrode in an air fuel cell stack, the system (1000) comprising:
a cell frame (101);
one or more anode array (102), wherein the one or more anode array (102) is detachably provided with the cell frame (101) and wherein the one or more anode array (102) comprises one or more anode;
one or more air cathode (103), wherein the one or more air cathode (103) is provided with the cell frame (101);
one or more connector (105), wherein the one or more connector (105) connects the one or more air cathode (103) and the one or more anode array (102); and
a snap fit mechanism (106) for locking and unlocking the one or more anode array (102) to the cell frame (101).

2. The system (1000) as claimed in claim 1, wherein the system (1000) further comprises one or more nozzle (104) providing a passage of gas evolution during an electrochemical reaction, wherein the one or more nozzles (104) is placed on a lid (109).

3. The system (1000) as claimed in claim 1, wherein the system (1000) further comprises a gas evolution section (107) and a gasket (108) sealing the air fuel cell stack and preventing a leakage of electrolyte and gas from the system (1000).

4. The system (1000) as claimed in claim 1, wherein the system (1000) further comprises a lid (109) covering the cell frame (101), the one or more anode array (102), the one or more air cathode (103), one or more nozzle (104), the one or more connector (105), a gas evolution section (107), and a gasket (108).

5. The system (1000) as claimed in claim 1, the one or more connector (105) connecting one or more air cathode (103) in a parallel.

6. The system (1000) as claimed in claim 1, wherein the one or more connector (105) connects the one or more cathode (103) and the one or more anode array (102) in a series manner.

7. The system (1000) as claimed in claim 1, wherein a top part of the one or more anode array (102) is designed to collect a gas evolved during an electrochemical reaction in the system (1000).

8. The system (1000) as claimed in claim 1, wherein a first anode from the anode array (102) is configured to be inserted between two air cathodes in the air fuel cell stack, so as to ensure that an active area of the first anode and an active area of the two air cathodes to perform an electrochemical reaction.

9. The system (1000) as claimed in claim 1, wherein the system (1000) further comprises a connector clip made of a highly conductive material coated with an alkaline resistive material.

10. The system (1000) as claimed in claim 1, wherein the system (1000) further comprises a dovetail groove and fixture design in a connector clip is provided to tightly grip and hold anodes and the one or more air cathodes (103).

11. A method for managing an electrode in an air fuel cell stack, the method comprising:
providing a cell frame (101);
providing one or more anode array (102), wherein the one or more anode array (102) is detachably provided with the cell frame (101) and wherein the one or more anode array (102) comprises one or more anode;
providing one or more air cathode (103) with the cell frame (101);
connecting the one or more air cathode (103) and the one or more anode array (102) by using one or more connector (105); and
locking and unlocking the one or more anode array (102) to the cell frame (101) by using a snap mechanism (106).

12. The method as claimed in claim 11, wherein the method further comprises providing a passage of gas evolution during an electrochemical reaction by using one or more nozzle (104), wherein the one or more nozzles (104) is placed on a lid (109).
